(19) United States
(12) Patent Application Publication
(10) Pub. No.: US 2024/0044182 A1
(43) Pub. Date: Feb. 8, 2024

(54) FASTENING A BOWDEN CABLE ELEMENT TO A FORCE-TRANSMISSION ELEMENT

(71) Applicant: BROSE SCHLIESSSYSTEME GMBH & CO. KOMMANDITGESELLSCHAFT, Wuppertal (DE)

(72) Inventor: Ludger GRAUTE, Essen (DE)

(21) Appl. No.: 18/266,769

(22) PCT Filed: Dec. 6, 2021
(86) PCT No.: PCT/EP2021/084309

§ 371 Date: Jun. 12, 2023

(30) Foreign Application Priority Data
Dec. 10, 2020 (DE) 10 2020 133 064.2

(51) Int. Cl. E05B 79/20; E05B 81/04; E05B 81/90; E05B 77/36

(52) U.S. Cl. CPC E05B 79/20; E05B 81/04; E05B 81/90; E05B 77/36

(57) ABSTRACT

A force-transmission device for an actuation mechanism of a movable vehicle element. The force-transmission device includes a movably held force-transmission element, a Bowden cable element having an end, an end piece fastened to the end of the Bowden cable element, and a stop. The movably held force-transmission element is held in a manner preloaded in a first direction into an end position by a preload force and is movable in a second direction opposite to the first direction in order to transmit an actuating force for the actuation mechanism. The end piece of the Bowden cable element is held against the movably held force-transmission element. The movably held force-transmission element transmits, in the end position, at least a portion of the preload force to the end piece of the Bowden cable element, and the end piece is held so as to be pressed against the stop.

### CROSS-REFERENCE TO RELATED APPLICATIONS

This application is the U.S. National Phase of PCT/EP2021/084309 Filed Dec. 6, 2021, which claims Priority to DE 10 2020 133 064.2 Filed Dec. 10, 2020, the entire disclosures of which are incorporated by reference herein.

### TECHNICAL FIELD

The present invention relates to the attachment of a cable pulling element to a force transmission element and relates to a force transmission device for an actuating mechanism of a movable vehicle element, an actuating module, a vehicle opening module and a method of holding a force transmission device for an actuating mechanism of a movable vehicle element.

### BACKGROUND

Cable pulling elements are used to transmit actuating forces, for example in vehicle door locks, for example in the form of Bowden cables in which a core runs in a sheath. In particular, a cable pull can be used to transmit tensile forces between two components, for example between an actuator and a door lock. In vehicle doors, for example, wire rope hoists are also used as additional, i.e. secondary or redundant, force transmission components if the lock is designed with an integrated electric motor and a manual opening option for the lock is to be ensured for safety. However, tensioning the additional wire rope hoists involves effort during installation. Such additional wire rope hoists are therefore also connected, for example, without tension, to a lever of the lock that is to be actuated. Other wire rope hoists used as primary power transmission components can also be loosely held. It has been shown that this can result in small noises if, for example, an end piece is not correctly in contact with the lever. These noises are perceived as annoying due to the overall increasing demands on the acoustic properties of vehicles.

### SUMMARY

An object of the present disclosure includes providing an improved attachment for cable pulls, for example Bowden cables.

According to one aspect of the present disclosure, a force transmission device is provided for an actuating mechanism of a movable vehicle element. The force transmission device comprises a movably held force transmission element, a stop, and a cable pulling element having an end and an end piece attached to the end of the cable pulling element. The movably held force transmission element is held biased in a first direction with a preload force to an end position; further, the movably held force transmission element is movable in a second direction opposite to the first direction to transmit a positioning force for the actuating mechanism. The cable pulling element is supported by the end piece on the movably supported force transmission element. In the end position, the movably held force transmission element transmits at least part of the preload force to the end piece of the cable pulling element, and the end piece is held pressed against the stop.

The movably held force transmission element is movable in the second direction to an actuating position to transmit the positioning force for the actuating mechanism. The movably held force transmission element is thus movable between the end position and the actuating position. The end position at the stop can also be referred to as the first end position and the actuating position as the second end position.

The end position forms, so to speak, a rest position or rest position and the actuation position forms an active position or active position.

Holding the end piece against the stop provides immobilization of the end of a cable pulling element, for example a Bowden cable, i.e. a so-called Bowden cable immobilization. For example, this prevents rattling or loosening.

The force transmission device can also be referred to as the force transmission mechanism.

The movable vehicle element may be a vehicle door, tailgate, or front hood, i.e., a motor vehicle door, a motor vehicle tailgate, or a motor vehicle front hood.

The term motor vehicle door refers to side doors and rear doors. Doors can be doors that swing to the side or swing upward, or they can be sliding doors, or they can be swivel-slide doors.

The term motor vehicle hatch or motor vehicle tailgate refers to folding or pivoting elements, in particular in the rear area of the vehicle, to allow access in this area. The term motor vehicle tailgate also refers to trunk lids, which are also referred to as trunk lids, with which a trunk or stowage space located in the rear area of the vehicle is movably closed.

The term motor vehicle front hood refers to folding or pivoting elements in the front area of the vehicle to allow access in this area. The term motor vehicle front hood also refers to hoods that movably close off an engine compartment. The term motor vehicle front hood also refers to so-called front trunks, also known as frunks, i.e. flaps or lids with which a trunk or stowage space located in the front area of the vehicle is movably closed.

The term actuating mechanism refers to the actuating device of a movable vehicle element.

The actuating mechanism may, for example, relate to a lock of the movable vehicle element and be designed as a locking mechanism. The locking mechanism comprises, for example, a lock of a motor vehicle door, a motor vehicle tailgate, or a motor vehicle front hood. The term lock refers to the releasable locking of the movable component.

The actuating mechanism may, for example, relate to the movement of the movable vehicle element, and may be in the form of a movement mechanism. The movement mechanism comprises, for example, a closing aid or opening aid for a motor vehicle door.

The term closing aid refers to a mechanism with which the closing process of the movable component is actively supported. The closing aid is intended, for example, to pull a movable component, e.g. a vehicle door, into a lockable position, for example from a pre-engagement position into a main engagement position, in which locking by a lock can then take place.

The term opening aid refers to a mechanism with which the opening process of the movable component is actively supported. The opening aid is provided, for example, for pressing a movable component, e.g. a vehicle door, into an open position. The opening aid may, for example, be a drive provided for releasing a pawl of a lock, so that, for example, an electric opening releases the pawl. The opening aid can, for example, be a drive that acts on the rotary latch in order to use it to actively push the door open slightly, or also to move the rotary latch so that the door seal, which is compressed in the closed state, pushes the door open. The opening aid can also be provided as a drive for locking and unlocking a door lock. The opening aid can be designed, for example, as a push-out device, for example as a drive that presses directly on the door, for example as a so-called push-out unit. The opening aid can, for example, be designed as an opening drive, for example in the case of a tailgate or trunk lid.

The term force transmission element refers to a movable component that transmits a force generated by an actuator, such as a servomotor, manually operated handle, or other actuator. For example, a force is transmitted to actuate the actuating mechanism.

The term cable pulling element refers to a linear, but transversely flexible element for transmitting a tensile force. The element is designed as a cable, for example as the core of a Bowden cable.

The term preload force refers to a force acting in the first direction on the force transmission element in a substantially permanent manner.

The preload force is applied, i.e. transmitted, to the movably held force transmission element. The movably held force transmission element transmits at least part of the preload force to the end piece of the cable pulling element, and the end piece of the cable pulling element introduces at least part of the preload force into the stop, i.e. transmits at least a part of the preload force to the stop.

The term stop refers to a contact surface against which the end piece can be held. The stop can be designed as a separate element. The stop can also be formed as a contour or contact surface that is also formed for other purposes, for example a housing structure of the actuating mechanism.

In an example, the movably held force transmission element presses the end piece of the cable pulling element against the stop in the end position. Preferably, a single stop is provided. For example, the preload force is transmitted completely to the stop.

Alternatively, two parallel stops may be provided. In an example, the movably held force transmission element in the end position presses the end piece of the cable pulling element against a first stop, e.g. an end piece stop, whereby the movably held force transmission element in the end position rests with a contact surface against a second stop, e.g. a force transmission element stop. The preload force is transmitted in part via the end piece to the end piece stop and in part via the force transmission element to the force transmission element stop.

In an example, the movably held force transmission element is designed to transmit at least part of the preload force to the end piece of the cable pulling element in the end position and to press the end piece against the stop, i.e. to hold it pressed.

In an example, a force flow of the preload force applied to the force transmission element is present from the force transmission element via the end piece to the stop. For example, the force flow of the preload force to the stop is completely via the end piece. Alternatively, the force flow of the preload force can be partially applied to the stop via the end piece.

The end position corresponds to an unactuated end position of the force transmission element.

The movably held force transmission element is, for example, a force transmission lever pivotally held to a base structure. In an example, the stop is provided, i.e. attached or formed, on the base structure.

According to an example, in the end position, the movably held force transmission element abuts the stop via the end piece of the cable pulling element so that the end piece is held clamped between the force transmission element and the stop.

The clamped hold is particularly suitable for Bowden cable suspensions where the levers do not experience any pre-tension via the Bowden cable. The clamped holding prevents rattling or other disturbing noises while driving, since the suspension can no longer move unintentionally in relation to the lever. In addition to the acoustic advantages, a loss of function is also prevented due to the secure fastening to the lever, for example a form-fit fastening. The fastening described is particularly suitable for steel levers in combination with metal suspensions.

The Bowden cable hook is clamped between the spring-loaded lever and the lever stop when the lever is not actuated. This is achieved by a special contour on the Bowden cable hook, i.e. on the bottom cable piece, which is attached to the lever, for example hooked in. As an advantage, no further decoupling measures, such as additional plastic clipping or overmolding, are necessary. Due to the secure hold (by the clamped holding), a migration of the Bowden cable end piece out of the lever is prevented when the Bowden cable is not pre-tensioned.

According to an example, the cable pulling element is a core of a Bowden cable.

The Bowden cable can, for example, be a Bowden cable for emergency actuation of a motor vehicle lock that can be unlocked by a motor.

In an alternative or additional option, the cable pulling element is provided with the end piece suspended from the movably held force transmission element.

For example, the end piece comprises a contact area that forms a contact surface transverse to the first direction and that is configured to abut the stop in the end position.

The end piece is made of metal, for example, a die-cast that is cast or pressed onto the end of the rope.

In another example, the end piece is plastic molded onto the end of the rope.

According to an example, the end piece comprises a contact area that forms a contact surface in the first direction and that is configured to abut the stop in the end position.

The contact area can also be referred to as the clamping area or clamping contour.

According to an example, the contact area is formed as a projection that protrudes over the force transmission element in the first direction and that abuts the stop in the end position.

According to an example, the force transmission element is movable in a swivel plane and the contact area is arranged laterally offset to the swivel plane. The stop comprises a stop area laterally offset from the swivel plane.

The stop area can also be referred to as the holding area, holding contour or stop contour.

For example, the force transmission element projects beyond the stop area in the end position. In another example, the stop area protrudes beyond the force transmission element.

For example, the contact surface is rounded in a pivoting direction of the force transmission element.

According to an example, the end piece comprises an attachment projection that protrudes in a direction that is transverse to a direction of pull and that engages a recess of the force transmission element.

The direction of pull is, for example, the second direction. The fastening projection is designed, for example, as a hook that is hooked into a hole in the force transmission element. The fastening projection can also be referred to as a tensile attachment.

In an example, the end piece is hooked to the force transmission element with a bayonet connection. For example, the end piece is formed with a bayonet hook which is inserted into a recess of the force transmission element, for example into a through opening on the force transmission element, and is held in the operative position against loss on the force transmission element and is releasable in an assembly position which is rotated relative to the operative position by at least 15°, for example at least 30° or at least 45°. In an example, the mounting position is rotated relative to the operative position by at least 90°. The term “operative position” refers to the position of the end piece in relation to the force transmission element when transmitting the positioning force.

According to an example, the end piece is formed as a barrel attached to the end of the cable pulling element. The force transmission element comprises a barrel receptacle for attaching the barrel, and the barrel receptacle presses the barrel against the stop in the end position. The barrel receptacle is for example fork-shaped.

According to an example, a biasing element is provided for applying the preload force to the force transmission element.

In an example, the biasing element is formed as a biasing spring, e.g., a torsion spring. In an example, the biasing spring is held to the base structure. A first end of the biasing spring is in contact with the base structure and a second end is in contact with the force transmission element.

In another example, the biasing element is formed as a compression element arranged between the force transmission element and a biasing stop.

In an example, the power transmission lever comprises a first lever end, a second lever end, and a pivot bearing disposed therebetween. At the first lever end, the power transmission lever is connected to the end piece of the cable pulling element. At the second lever end, the force transmission lever comprises an engagement element for transmitting a positioning force applied via the cable pulling element to the actuating mechanism.

In an example, the biasing element is a spring that acts on the force transmission lever at the attachment point with a force of approximately 5 N.

According to an example, the cable pulling element is tension-free in the end position of the force transmission element.

In the end position of the force transmission element, the cable pulling element is free of applied tensile stress, i.e. it is untensioned. In this state, the cable pulling element does not exert any tensile force on the force transmission element.

Due to the holding of the end piece between the stop and the force transmission element, there can be no rattling if there is play in the holder of the end piece on the force transmission element.

According to the invention, also an actuating module for a movable vehicle element is provided. The actuating module comprises an actuating mechanism for the movable vehicle element. The actuating mechanism is formed as at least one of a lock, a closing aid and an opening aid. The actuating module also comprises a force transmission device with which a positioning force for the actuating mechanism can be transmitted. The force transmission device is designed according to one of the preceding examples.

In an example, the actuating mechanism is designed as a lock of a vehicle door or vehicle flap. The actuating module can also be referred to as a vehicle lock module.

In an example, the actuating mechanism is designed as a closing aid for a vehicle door or flap. In another example, the actuating mechanism is designed as an opening aid for a vehicle door or vehicle flap. The actuating module may also be referred to as a vehicle door movement module or a vehicle flap movement module.

According to an example, the actuating mechanism is motor-driven. The force transmission device is designed for manual emergency actuation of the motor-driven actuating mechanism.

Manual actuation can be performed, for example, via an emergency lever or emergency handle. The manual actuation can be performed, for example, via a concealed manually actuated cable pull area.

In an example, the force transmission device is designed for (manual) emergency actuation of a motor-unlockable vehicle lock.

In another example, the force transmission device is designed for (manual) emergency actuation of a motor-driven opening aid. In another example, the force transmission device is designed for (manual) emergency actuation of a motor-driven closing aid.

According to an example, the force transmission device is designed for manual or motor-driven actuation of the actuating mechanism.

In an example, the force transmission device is provided for manual normal operation of the actuating mechanism.

In an example, the force transmission device is provided for normal motor actuation of the actuating mechanism.

According to the invention, also a vehicle opening module is provided. The vehicle opening module comprises a movable vehicle element formed as at least one of the group of a motor vehicle door, a motor vehicle tailgate, and a motor vehicle front hood. The vehicle opening module further comprises an actuating module according to any of the preceding examples. The actuating mechanism of the actuating module is configured to actuate the movable vehicle element. The force transmission element of the force transmission device is adapted to transmit a positioning force for the actuating mechanism of the movable vehicle element.

In accordance with the invention, there is also provided a method for holding a force transmission device for an actuating mechanism of a movable vehicle element. The method comprises the following steps of: connecting an end piece of a cable pulling element attached to an end of the cable pulling element to a movably held force transmission element; holding the movably held force transmission element with a bias with a preload force in a first direction to an end position, the movably held force transmission element being movable in a second direction opposite to the first direction to transmit a positioning force for the actuating mechanism; and transmitting at least a portion of the preload force through the movably held force transmission element to the end piece of the cable pulling element in the end position and urgingly holding the end piece against a stop.

According to an aspect, the movable vehicle element, for example a motor vehicle door, a motor vehicle tailgate or a motor vehicle front hood, is formed with a lock, a closing aid or an opening aid. The lock, the closing aid or the opening aid is formed with a force transmission device with which a positioning force generated manually or by an actuator can be transmitted. A cable pull is provided for transmission, for example a Bowden cable with core and sheath. The cable, e.g. the core, is formed with an end piece at one end. The end piece is connected to the force transmission element of the force transmission device. The end piece is pressed against a stop by a preload force of the force transmission element.

It should be noted that the features of the embodiments force transmission device for an actuating mechanism of a movable vehicle element also apply to embodiments of the actuating module for a movable vehicle element, the vehicle opening module and the method for holding a force transmission device for an actuating mechanism of a movable vehicle element and vice versa. Furthermore, also those features can be freely combined with each other where this is not explicitly mentioned.

### BRIEF DESCRIPTION OF THE DRAWINGS

In the following, examples of embodiments of the invention are described in more detail with reference to the accompanying drawings.

FIG. 1 shows a schematic diagram of an example of a force transmission device.

FIG. 2 shows a perspective view of a further example of a force transmission device in connection with an actuating mechanism of an actuating module in the form of a door lock.

FIG. 3 shows another perspective view of the example in FIG. 2.

FIGS. 4A and 4B show the force transmission device in FIG. 4A in an end position (as rest position) and in FIG. 4B in an actuation position (as active position).

FIG. 5 shows an additional example of the attachment of the end piece to the movably held force transmission element.

FIG. 6 shows another example of the attachment of the end piece to the movably held force transmission element.

FIG. 7 shows yet another example of the attachment of the end piece to the movably held force transmission element.

FIG. 8 shows another example of the attachment of the end piece to the movably held force transmission element.

FIG. 9A, FIG. 9B and FIG. 9C show the movably held force transmission element provided in FIG. 2 in FIG. 9A in an oblique view from above, in FIG. 9B and FIG. 9C in an oblique view from below. FIG. 9A and FIG. 9B show the end piece of the wire rope hoist in relation to the force transmission element in an installed state; FIG. 9C shows the end piece of the wire rope hoist in relation to the force transmission element in an assembled state.

FIG. 10 shows an example of a vehicle opening module in a schematic view.

FIG. 11 shows steps of an example of a method for holding a force transmission device for an actuating mechanism of a movable vehicle element.

### DETAILED DESCRIPTION OF EMBODIMENTS

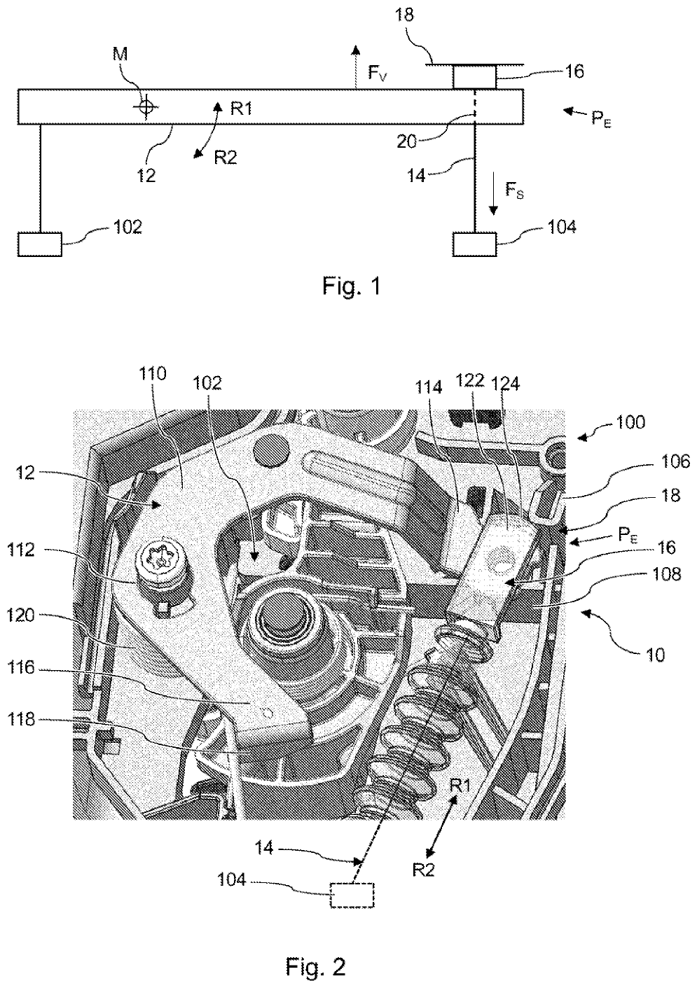

FIG. 1 shows a schematic representation of an example of a force transmission device 10 for an actuating mechanism of a movable vehicle element. The force transmission device 10 comprises a movably held force transmission element 12. Further, the force transmission device 10 comprises a cable pulling element 14 having an end and an end piece 16 attached to the end of the cable pulling element. The force transmission device 10 also comprises a stop 18. The movably held force transmission element 12 is held preloaded in a first direction R1 with a preload force F_{V} into an indicated end position P_{E}. The movably held force transmission element 12 is movable in a second direction R2, which is opposite to the first, to transmit a positioning force F_{S} for the actuating mechanism (not shown in detail in FIG. 1). The cable pulling element 14 is held, i.e. fixed, to the movably held force transmission element 12 by the end piece 16. In the end position P_{E}, the movably held force transmission element 12 transmits at least part of the preload force F_{V} to the end piece 16 of the cable pulling element 14, and the end piece 16 is held pressed against the stop 18.

The movably held force transmission element 12 is shown as a pivoted lever, i.e. as a rotationally movable element. However, the movably held force transmission element 12 can also be designed as a translationally movable element. The movement of the movably held force transmission element 12 in the first and second directions R1 and R2 is exemplarily indicated as a pivoting movement about a pivot bearing, or pivot point M, but can also be designed as a sliding movement, or as a combination thereof.

FIG. 2 shows a perspective view of another example of the force transmission device 10 in connection with an actuating mechanism, configured as a door lock, of an actuating module 100 for a movable vehicle element not shown in more detail, for example a vehicle door or vehicle flap.

The actuating module 100 comprises an actuating mechanism 102 (also indicated as an option in FIG. 1) for the movable vehicle element. The actuating mechanism 102 is designed, for example, as a lock, e.g. as a lock of a vehicle door, a vehicle tailgate or a vehicle front hood. The lock comprises, for example, a locking and unlocking mechanism to releasably hold a locking bar. The movably held force transmission element 12 of the force transmission device 10 is a lever that is operatively connected to the locking and unlocking mechanism of the lock. The lock can be unlocked by pulling on the cable pulling element 14, for example for emergency opening. The active connection is only temporary, for example, when the cable pulling element 14 is activated.

The actuating mechanism 102 may also be configured as a closing aid of the movable vehicle element or as an opening aid of the movable vehicle element. The actuating module 100 further comprises an example of the force transmission device 10, which can be used to transmit the Positioning force F_{S} for the actuating mechanism 102. The Positioning force F_{S} may be provided, for example, via a manual actuation of the cable pulling element 14. The Positioning force F_{S} can also be effected, for example, by an actuator 104, which is indicated as an option in dashed lines in FIG. 2 (also indicated as an option in FIG. 1). The actuator 104 can be a handle or lever, for example an emergency handle or emergency lever. The actuator 104 is connected via the cable pulling element 14. The force transmission device 10 is formed according to any of the preceding and following examples.

The actuator is, for example, an electric actuator, such as a linearly operable electromagnetic actuator (electromagnetic actuator) or a rotationally operable electromagnetic actuator (electric motor).

In the example indicated in FIG. 2, the actuating mechanism 102 is motor-driven. For example, an electric lock motor is provided, but is not shown in detail in FIG. 2. For example, the force transmission device 10 is configured for manual emergency actuation of the motor-driven actuating mechanism 102, for example, if the electric lock motor is defective or no electrical power is available to open the lock with the electric lock motor.

In a further option, it is provided that the force transmission device 10 is designed for (so to speak regular) manual or motor-driven actuation of the actuating mechanism 102.

In FIG. 2, the stop 18 is formed as a projection 106 of a housing structure 108. The movably held force transmission element 12 is formed as a pivotable lever 110, which is rotatably attached to a pivot bearing 112 about the pivot point M and comprises a first lever arm 114 and a second lever arm 116. The end piece 16 of the cable pulling element 14 is held on the first lever arm 114. For example, a projection 118 is formed on the second lever arm 116 for engagement with the actuating mechanism 102.

According to an example, shown as an option in FIG. 2, a biasing element 120 is provided for applying the preload force F_{V} to the force transmission element 12. The biasing element 120 is, for example, a spring element.

According to an example indicated in FIG. 2, the cable pulling element 14 is a core of a Bowden cable, which may optionally comprise a Bowden cable sheath.

According to an example indicated in FIG. 2, the cable pulling element is held in the end position P_{E} of the force transmission element 12 without tension.

According to an example indicated in FIG. 2, in the end position P_{E}, the movably held force transmission element 12 rests against the stop 18 via the end piece 16 of the cable pulling element 14, so that the end piece 16 is held clamped between the force transmission element 12 and the stop 18.

According to an example indicated in FIG. 2, it is optionally provided that the cable pulling element 14 is hooked with the end piece 16 to the movably held force transmission element 12.

According to an example indicated in FIG. 2, the end piece 16 comprises a contact area 122 that forms a contact surface 124 in the first direction R1 and that is configured to abut the stop 18 in the end position P_{E}.

According to an example indicated in FIG. 2, the contact area 122 is formed as a projection 125 that protrudes over the force transmission element in the first direction R1 and that abuts the stop 18 in the end position P_{E}.

According to an alternative example, the force transmission element 12 is movable in a swivel plane and the contact area is arranged laterally offset to the swivel plane. The stop 18 comprises a stop area laterally offset with respect to the pivot plane. The contact area can be formed as a recess if the stop 18 is arranged next to the force transmission element 12, as it were, and projects laterally past the force transmission element 12.

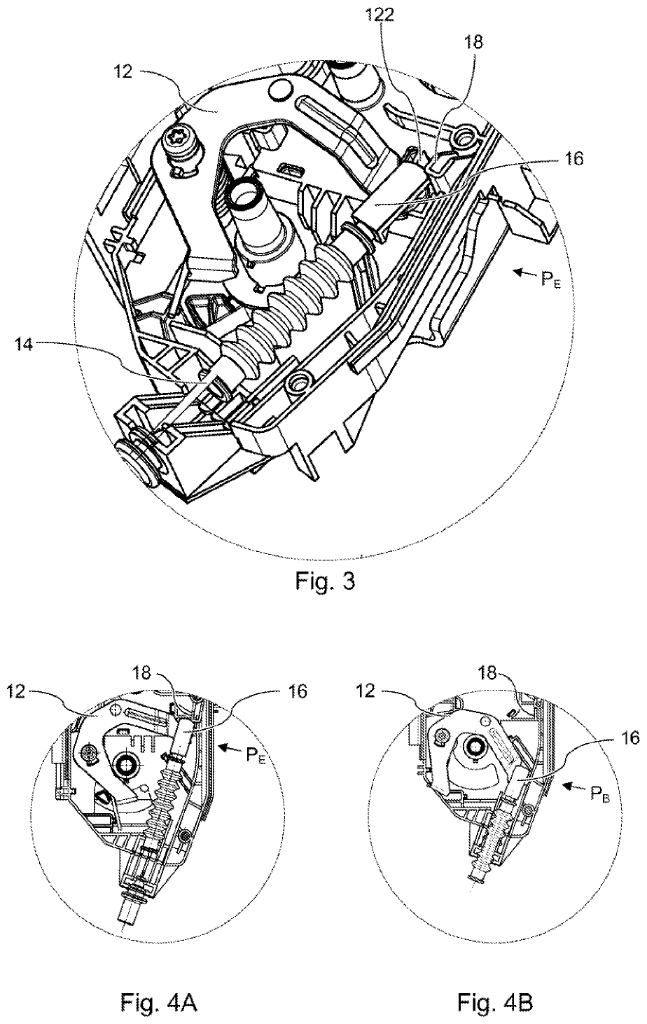

FIG. 3 shows another perspective view of the example in FIG. 2.

FIGS. 4A and 4B show the force transmission device in FIG. 4A in the end position P_{E} (as rest position) and in FIG. 4B in an actuation position PB (as active position).

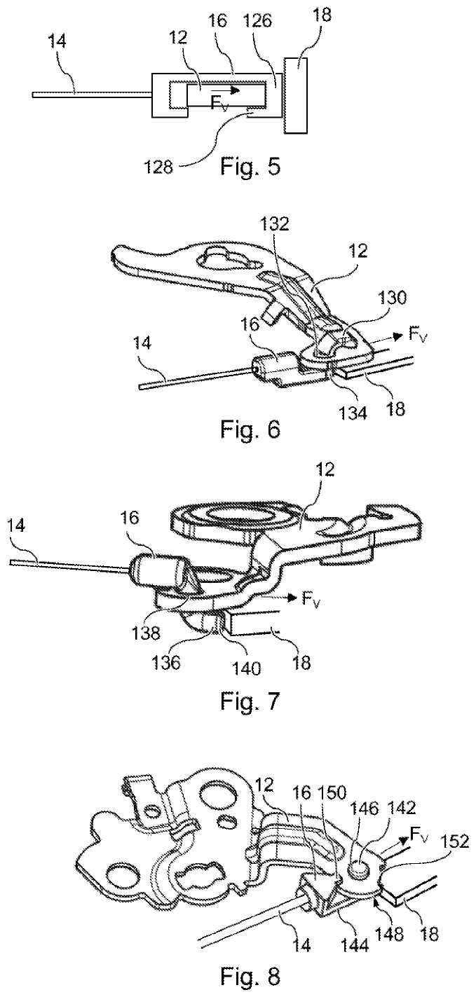

FIG. 5 shows an additional example of the attachment of the end piece 16 to the movably held force transmission element 12. The end piece 16 partially surrounds the force transmission element 12 and rests on a side of the force transmission element 12 facing away from the cable of the cable pulling element with a hook-shaped projection 126 on the force transmission element. The pre-tensioned force transmission element 12 presses the projection 126 against the stop 18. The projection 126 is formed, for example, with a rim segment 128 encompassing the force transmission element 12, resulting in a C-shaped cross-section. This ensures that the projection 126 does not disengage from the force transmission element 12. Optionally, a second encompassing edge segment may be provided. In an example, only a single encompassing edge segment is provided when viewed in cross-section.

FIG. 6 shows another example of the attachment of the end piece 16 to the movably supported force transmission element 12. The end piece 16 comprises a hook 130 that engages a recess 132 of the force transmission element 12. The hook 130 protrudes through the recess 132 from a first side and protrudes from a second side. The stop 18 engages the end piece at the first side, where the end piece is formed with a stop edge 134 for abutting the stop 18.

FIG. 7 shows another example of the attachment of the end piece 16 to the movably retained force transmission element 12. The end piece 16 comprises a projection 136 that engages and extends through a recess 138 of the force transmission element 12, where it forms an abutment 140 for the stop 18.

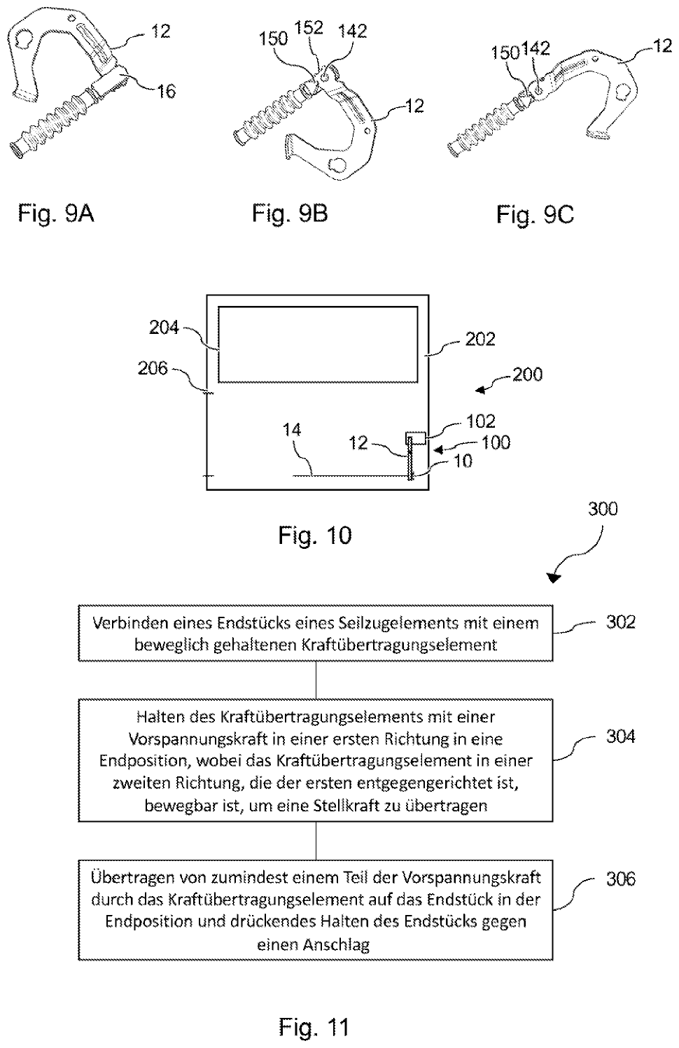

FIG. 8 shows another example of the attachment of the end piece 16 to the movably retained force transmission element 12. The end piece 16 comprises an attachment projection 142 that protrudes from a lateral tab area 144 in a direction that is transverse to a direction of pull and that engages a recess 146 of the force transmission element 12. The stop 18 engages the side of the force transmission element 12 at a contact area 148 of the side tab region 144. Optionally, a locking projection 150 is formed to allow release of the end piece 16 from the force transmission element 12 only when in a suitably aligned position over a recess 152. The locking projection 150 and the recess 152 form a bayonet lock of the end piece to the force transmission element 12 (see also FIG. 9A, FIG. 9B and FIG. 9C).

FIG. 9A shows a section of the force transmission element 12 with the end piece 16 movably attached to it from a first side, which can also be referred to as the front side. FIG. 9B and FIG. 9C show the force transmission element 12 with the end piece 16 movably held thereto from another side, which can also be referred to as the rear side.

FIG. 9A and FIG. 9B show the force transmission element 12 with the end piece 16 movably held thereto in an installed position relative to each other. The locking projection 150 is offset from the recess 152. The locking projection 150 prevents the end piece 16 from detaching from the force transmission element 12.

In FIG. 9C, the locking projection 150 and the recess 152 are aligned with respect to each other to allow assembly (e.g., mounting) or disassembly (e.g., for maintenance, repair, or disassembly) of the end piece 16 from the force transmission element 12.

According to an example not shown in more detail, it is optionally provided that the end piece of the cable is formed as a barrel that is attached to the end of the cable pulling element. The force transmission element comprises a barrel receptacle for attaching the barrel and the barrel receptacle presses the barrel against the stop in the end position P_{E}.

FIG. 10 shows an example vehicle opening module 200 in a schematic view. The vehicle opening module 200 comprises a movable vehicle element 202, which is at least one of a motor vehicle door, a motor vehicle tailgate and a motor vehicle front hood. In FIG. 10, a vehicle door having a window portion 204 and two hinges 206 is schematically indicated. The vehicle opening module 200 further comprises the actuating module 100 according to any of the preceding examples.

The actuating mechanism 102 of the actuating module 100 is designed for actuating the movable vehicle element 202. The force transmission element 12 of the force transmission device 10 can be used to transmit a positioning force for the actuating mechanism 102 of the movable vehicle element 202. For example, the cable pulling element 14 can be provided for emergency opening in the door area.

The actuating mechanism 102 is, for example, a lock of a vehicle door.

In another example, the actuating mechanism 102 is an opening aid or a closing aid of a vehicle door.

In another example, the actuating mechanism 102 is an opening aid or a closing aid of a vehicle door.

In still another example, the actuating mechanism 102 is an opening aid or a closing aid of a vehicle tailgate or a vehicle front hatch.

In the example shown in FIG. 10, the actuating module 100 is arranged in the movable vehicle element 202. In an alternative example, the actuating module 100 is arranged in a frame area (not shown) of the vehicle.

FIG. 11 shows steps of an example of a method 300 for holding a force transmission device for an actuating mechanism of a movable vehicle element. The method 300 comprises the following steps: In a first step 302, also referred to as step a), an end piece of a cable pulling element attached to an end of the cable pulling element is connected to a movably held force transmission element. In a second step 304, also referred to as step b), the movably held force transmission element is biased with a preload force in a first direction to an end position, the movably held force transmission element being movable in a second direction opposite to the first direction to transmit a positioning force for the actuating mechanism. In a third step 306, also referred to as step c), at least a portion of the preload force is transmitted through the movably held force transmission element to the end piece of the cable pulling element in the end position and the end pieces is held pressing against a stop.

The embodiments described above may be combined in various ways. In particular, aspects of the devices can also be used for the embodiments of the method and vice versa.

Supplementally, it should be noted that “comprising” does not exclude other elements or steps, and “one” or “a” does not exclude a plurality. It should further be noted that features or steps that have been described with reference to any of the above embodiments may also be used in combination with other features or steps of other embodiments described above. Reference signs in the claims are not to be regarded as a limitation.

1. A force transmission device for use in an actuating mechanism of a movable vehicle element, the force transmission device comprising:
a movably held force transmission element;
a cable pulling element having an end and an end piece attached to the end of the cable pulling element; and
a stop,
wherein the movably held force transmission element is held biased in a first direction with a preload force to an end position, and is movable in a second direction, opposite the first direction, to transmit a positioning force for the actuating mechanism,
wherein the cable pulling element is supported by the end piece on the movably supported force transmission element, and
wherein when the movably held force transmission element is in the end position, the movably held force transmission element transmits at least a part of the preload force to the end piece of the cable pulling element and the end piece is held pressed against the stop.

2. The force transmission device of claim 1, wherein when the movably held force transmission element is in the end position, the movably held force transmission element abuts the stop in the end position via the end piece of the cable pulling element so that the end piece is held clamped between the movably held force transmission element and the stop.

3. The force transmission device of claim 1, wherein the cable pulling element is a core of a Bowden cable hooked to the movably held force transmission element with the end piece.

4. The force transmission device of claim 1, wherein the end piece comprises a contact area forming a contact surface facing the first direction and adapted to abut the stop when the movably held force transmission element is in the end position.

5. The force transmission device claim 1, wherein the contact area is formed by a projection, the projection projects in the first direction beyond the force transmission element, and when the movably held force transmission element is in the end position the projection bears against the stop.

6. The force transmission device of claim 1, wherein the end piece comprises an attachment projection that protrudes in a direction transverse to a pulling direction and that engages a recess of the force transmission element.

7. The force transmission device of claim 1, wherein the end piece is formed as a barrel attached to the end of the cable pulling element, the force transmission element comprises a barrel receptacle for mounting the barrel, and wherein the barrel receptacle is configured to press the barrel against the stop in the end position.

8. The force transmission device of claim 1, further comprising:
a biasing element configured to apply the preload force to the force transmission element.

9. The force transmission device of claim 1, wherein the cable pulling element is tension-free when the movably held the force transmission element is in the end position.

10. An actuating module for a movable vehicle element, the actuating module comprising:
an actuating mechanism for the movable vehicle element; wherein the actuating mechanism is formed as at least one of the group of a lock, a closing aid, and an opening aid; and
a force transmission device configured to transmit a positioning force for the actuating mechanism, wherein the force transmission device includes:
a movably held force transmission element;
a cable pulling element having an end and an end piece attached to the end of the cable pulling element; and
a stop;
wherein the movably held force transmission element is held biased in a first direction with a preload force to an end position, and is movable in a second direction opposite to the first to transmit a positioning force for the actuating mechanism;
wherein the cable pulling element is supported by the end piece on the movably supported force transmission element; and
wherein the movably held force transmission element in the end position transmits at least a part of the preload force to the end piece of the cable pulling element and the end piece is held pressed against the stop.

11. The actuating module of claim 10, wherein the actuating mechanism is formed as a lock of a vehicle door, a vehicle tailgate, or a vehicle front hood;
wherein the lock comprises a locking and unlocking mechanism for releasably holding a locking bar;
wherein the movably held force transmission element is a lever movable into operative connection with the lock locking and unlocking mechanism; and
wherein the lock is unlockable by pulling on the cable pulling element.

12. The actuating module of claim 10, wherein said actuating mechanism is motor driven; and
wherein the force transmission device is adapted for manual emergency actuation of the motor-driven actuating mechanism.

13. The actuating module of claim 10, wherein the force transmission device is designed for manual or motor-driven actuation of the actuating mechanism.

14. A vehicle opening module comprising:
a movable vehicle element formed as at least one of a motor vehicle door, a motor vehicle tailgate, and a motor vehicle front hood; and
an actuating module is an actuating module for a movable vehicle element, the actuating module comprising:
an actuating mechanism for the movable vehicle element wherein the actuating mechanism is formed as at least one of the group of a lock, a closing aid, and an opening aid; and
a force transmission device, with which a positioning force for the actuating mechanism is transmittable;
wherein the force transmission device is a force transmission device for an actuating mechanism of a movable vehicle element, the force transmission device comprising:
a movably held force transmission element;
a cable pulling element having an end and an end piece attached to the end of the cable pulling element; and
a stop;
wherein the movably held force transmission element is held biased in a first direction with a preload force to an end position, and is movable in a second direction opposite to the first to transmit a positioning force for the actuating mechanism;
wherein the cable pulling element is supported by the end piece on the movably supported force transmission element; and
wherein the movably held force transmission element in the end position transmits at least a part of the preload force to the end piece of the cable pulling element and the end piece is held pressed against the stop;
wherein the actuating mechanism of the actuating module is adapted to actuate the movable vehicle element; and
wherein the force transmission element of the force transmission device is adapted to transmit a positioning force for the actuating mechanism of the movable vehicle element.

15. A method of holding a force transmission device for an actuating mechanism of a movable vehicle element, the method comprising:
connecting an end piece of a cable pulling element attached to an end of the cable pulling element to a movably held force transmission element;
holding the movably held force transmission element with a bias with a preload force in a first direction to an end position, wherein the movably held force transmission element is movable in a second direction opposite the first direction to transmit a positioning force for the actuating mechanism; and
transmitting at least a portion of the preload force through the movably held force transmission element to the end piece of the cable pulling element in the end position and urgingly holding the end piece against a stop.

16. The force transmission device of claim 1, wherein the force transmission element is movable in a pivoting plane and the contact area is arranged laterally offset relative to the pivoting plane.

17. The force transmission device of claim 1, wherein the force transmission element is movable in a pivoting plane, and the stop includes a stop region, the stop region is laterally offset relative to the pivoting plane.

18. The actuating module of claim 11, wherein the lock includes a locking and unlocking mechanism configured to releasably hold a locking bar.

19. The actuating module of claim 18, wherein the lock is unlockable by pulling on the cable pulling element.

20. The actuating module of claim 11, wherein the movably held force transmission element is a lever movable into operative connection with the lock locking and unlocking mechanism.
